(19) United States
(12) Patent Application Publication
(10) Pub. No.: US 2003/0152716 A1
(43) Pub. Date: Aug. 14, 2003

(54) Coating method

(76) Inventors: Hans Hallen, Waterloo (BE); Karl-Erik Johansson, Hoganas (SE)

Correspondence Address: Benton S. Duffett, Jr., BURNS, DOANE, SWECKER & MATHIS, L.L.P., P.O. Box 1404, Alexandria, VA, 22313-1404, US

(21) Appl. No.: 10/164,628

(22) Filed: Jun. 10, 2002

(30) Foreign Application Priority Data
Feb. 14, 2002 (SE) 0200428-1

(51) Int. Cl. H05H 1/48

(52) U.S. Cl. 427/580

(57) ABSTRACT

The invention concerns a method of providing a coating having a predetermined hardness on a substrate comprising the steps of

attaching a magnetic steel powder on the outside of at least one consumable electrode core or wire, said powder including C and/or N in amounts selected in view of the predetermined hardness;

feeding the powder into a pool, which is formed by an arc between the electrode(s) and the substrate and which pool comprises molten material from the electrode, the substrate and the powder; and

cooling the coated substrate.

### FIELD OF INVENTION

The present invention concerns a process for thermal coating. More specifically the invention concerns a process for controlling the hardness of such a coating.

### BACKGROUND

By providing different substrates with a coating the life and performance of a component can be dramatically extended.

A recently developed method for producing thermal coatings based on the use of pre-alloyed powders is disclosed in the U.S. Pat. No. 6,331,688. According to this method several advantages can be achieved. Thus it was found that by using prealloyed powders in combination with consumable electrodes, coatings having a very uniform structure could be obtained. It was also found that this method resulted in a finer microstructure thereby reducing the risk of microcracks in the coating. The finer microstructure also lead to an increased strength. Other advantages were that the amounts of expensive alloying elements could be decreased due to the fact that the alloying elements were diluted by the base or substrate material to a comparatively small extent and that the coataing rates could be increased. According to this patent, which is hereby incorporated by reference, the coating method is based on submerged arc welding for coating of a metal substrate with one or more consumable electrode wires or electrode cords. The method comprises directly feeding of an atomised pre-alloyed metal powder containing high amounts of alloying elements into a weld pool, which is formed by the submerged arc and which consists of the melted electrode(s) and the melted substrate. The powder should be preferably magnetically attached to the outside of the melting consumable electrode(s). The powder is subsequently melted when fed into this pool.

The present invention is based on a further development of this method and is specifically directed to a method of controlling the hardness of the coating applied on the substrate. The possibility of increasing the hardness is often a important and deciding reason why a substrate is provided with a coating. Other important features of coatings are wear and corrosion resistance. According to the present invention it has now been found that a predetermined hardness of the final coating can be obtained by including selected amounts of C and/or N in the powder. The method according to the present invention is particularly suitable for coating substrates according to the submerged arc welding method and the open arc welding method.

### SUMMARY OF THE INVENTION

In brief the present invention concerns a method of providing a coating having a predetermined hardness on a substrate comprising the steps of

attaching a magnetic steel powder on the outside of at least one consumable electrode core or wire, said powder including C and/or N in amounts selected in view of the predetermined hardness;

feeding the powder into a pool, which is formed by an arc between the electrode(s) and the substrate and which pool comprises melted material from the electrode, the substrate and the powder; and

cooling the coated substrate.

### DETAILED DESCRIPTION OF THE INVENTION

The powder and the electrode are selected in view of the desired composition and properties of the final coating. This final coating will have a composition corresponding to that of the pool which is formed by the arc between the electrode(s) and the substrate and which comprises melted material from the electrode, the substrate and the powder. The composition and properties of the final coating are decided by several factors such as

composition and type of powder

composition and type of electrode

composition and type of substrate

energy input

coating rate

For a given electrode, a given powder composition and a given substrate, the hardness of the surface can be estimated from the above factors. By using the method according to the present invention a method of controlling the surface hardness is provided. A main object of the present invention is thus to provide a method of controlling the hardness of the final coating.

### The Powder

A preferred powder which can be used according to the invention is a pre-alloyed, magnetic steel powder prepared by water or gas atomisation. The most preferred powders are stainless steel powders, high speed steel powders or tool steel powders. The particle size of powder should preferably be less than 800 μm most preferably less than 500 μm. The powder may include specific amounts alloying elements such as Cr, Ni, Mo, Mn, V, Nb, Si, Co, Ti, W. Additionally the powder includes C and/or N in amounts required for the desired hardness. The present invention is not restricted to powders having particularly high amounts of the alloying elements.

The carbon content of the powder can be selected according to the following relationship 0.2x<C<5x or preferably 0.2x<C<3x wherein x is the carbon content (wt %) of the electrode wire or cord. The nitrogen content may preferably vary between 0.001 and 0.8% by weight of the powder composition.

The Electrode(s)

A main purpose of the melting electrode wire (or cord) is to provide sufficient heat for melting the metal powder and the substrate surface. A special advantage is that, if combined with different types of metal powders having different alloying elements, the same electrode wire (or cord) can be used for different types of coatings. The electrode may be an essentially unalloyed iron electrode, or an electrode including lower or higher amounts of alloying elements. According to an embodiment of the invention the composition of the electrode and the prealloyed powder is roughly the same except for the carbon and/or nitrogen levels. This does of course not exclude that the electrode and the powder have the same C and/or N content. The chemical composition of the electrode(s) as well as that of the powder are selected in view of the intended use of the final coating.

### The Substrate

The metal substrate can have essentially any form and the coating method according to the invention is only limited by practical considerations. Typical substrates could be low-alloy steels or tool steels, i.e. the chemical composition of the substrate can vary within a wide range.

### The Flux

The flux used in the method according to the invention is preferably a basic unalloyed flux.

### The Hardness

The invention is not limited to any specific hardness values. Important is however that by using the method according to the present it is possible to achieve a hardness within very specific narrow limits.

### The Method of Controlling the Hardness

More specifically the method according to the invention comprises the following steps:

1) deciding the hardness or hardness interval of the final coating;

2)determining the C and/or N content of the substrate;

3) selecting one or more consumable electrod(s) having a chemical composition adapted to the intended use of the final coating and having a known C and/or N content;

4) determining the degree of dilution of the substrate;

5) selecting a pre-alloyed, magnetic powder having a chemical composition adapted to the intended use of the final coating and having a known C and/or N content to give the desired hardness;

6) feeding the electode wire(s) and/or cord(s) having the powder magnetically attached thereto into the pool formed by an arc between the electrode(s) and the substrate and comprising melted substrate, melted electrode(s) and melted powder;

7) allowing the obtained pool to solidify and cool to a preselected temperature range;

8) optionally applying one ore more additional coating by repeating the steps 6)-7) until the desired hardness and C and/or N content has been obtained; and

9) determining the hardness and the C and/or N content of the obtained coating.

The preselected temperature range according to step 7) above depends on different factors, such as the number of layers (which form the final coating), the geometry, composition and size of the substrate. If, e.g. an additional layer is applied it is often suitable to cool the surface of the previous layer to a temperature of about 300-500° C. before this additional layer is applied.

The following example illustrates the method according to the invention.

### EXAMPLE 1

The desired minimum hardness was 37 HRC and the desired maximum hardness was 40 HRC and the carbon content of the surface should be between 0.09 and 0.12% by weight. An electrode wire having carbon content of 0.06% by weight was used. The C content of the substrate was 0.10% by weight. The C content of the used powder was 0.15%.

In the following table 1 the hardness reported as HRC is disclosed for four coated substrates having the different C contents.

TABLE 1

| C (%) of coated substrate | HRC |
|---|---|
| 0.05 | 33.8 |
| 0.08 | 36.4 |
| 0.10 | 38.2 |
| 0.12 | 40.0 |

Thus the powder must be supplemented with additional C compared with the wire composition.

With a dilution of the substrate of 25% and an amount of powder of 50% by weight related to the total amount of consumables, two layers were applied on the on the substrate. The carbon content of the powder tested was 0.15% by weight. The carbon content of the first and second layers was found to be 0.10% by weight.

The composition (% by weight) of the consumables (=the wire and the powder) and the substrate are found in the following table 2.

TABLE 2

| | Substrate | Wire | Powder |
|---|---|---|---|
| C | 0.10 | 0.06 | 0.15 |
| Mo | 0.5 | 1.1 | 0.7 |
| Ni | — | 4.8 | 3.9 |
| Mn | 0.5 | 0.7 | 0.9 |
| Cr | 1.5 | 12.9 | 13.0 |
| Si | 0.7 | 0.4 | 0.3 |

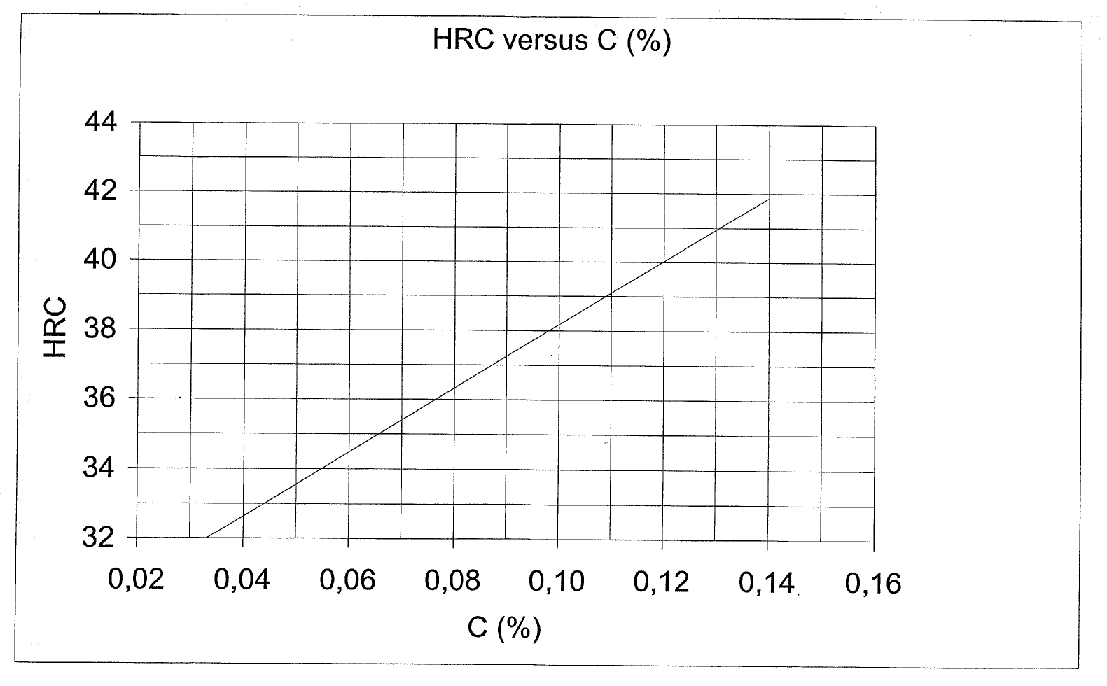

FIG. 1 demonstrates the hardness vs the carbon content in the range 0.04-0.14% for the alloy described in this example.

The composition of the investigated coating was Fe0.9Mo4.1Ni0.8Mn12.3CrO.4SiXC where 0.04<X<0.14.

1. A method for providing a coating having a predetermined hardness on a substrate comprising the following steps:
1) deciding the hardness or hardness interval of the final coating;
2) determining the C and/or N content of the substrate;
3) selecting one or more consumable electrodes having a chemical composition adapted to the intended use of the final coating and having a known C and/or N content;
4) determining the degree of dilution of the substrate;
5) selecting a pre-alloyed, magnetic steel powder having a chemical composition adapted to the intended use of the final coating and having a known C and/or N content to give the desired hardness;
6) feeding the electrode wire(s) and/or cord(s) having the powder magnetically attached thereto into the pool formed on the substrate by an arc between the electrode(s) and the substrate and comprising melted substrate, melted electrode and melted powder;
7) allowing the obtained pool to solidify and cool to a preselected temperature range;
8) optionally applying one or more additional coatings by repeating the steps 6)-7) until the desired hardness and C and/or N content has been obtained; and
9) determining the hardness and optionally the C and/or N content of the obtained coating.

2. The method according to claim 1 wherein the steel powder is a water-atomised or gasatomised powder.

3. The method according to claim 1 wherein the steel powder is a stainless steel powder, a high speed steel powder or a tool steel powder.

4. The method according to claim 3 wherein the powder has a particle size less than 800 μm.

5. The method according to claim 1 wherein the substrate is a low alloy steeel or a tool steel.

6. A method of providing a coating having a predetermined hardness on a substrate comprising the steps of
attaching a magnetic steel powder on the outside of at least one consumable electrode core or wire, said powder including C and/or N in amounts selected in view of the predetermined hardness;
feeding the powder into a pool, which is formed by an arc between the electrode(s) and the substrate and which pool comprises molten material from the electrode, the substrate and the powder; and
cooling the coated substrate.
